(19) United States
(12) Patent Application Publication
(10) Pub. No.: US 2026/0186183 A1
(43) Pub. Date: Jul. 2, 2026

(54) OPTICAL LENS

(71) Applicant: Genius Electronic Optical (Xiamen) Co., Ltd., Xiamen (CN)

(72) Inventors: FUTANG HUANG, Xiamen (CN); WENSEN CHEN, Xiamen (CN); JIANPENG YANG, Xiamen (CN); JIA-SIN JHANG, Xiamen (CN)

(73) Assignee: Genius Electronic Optical (Xiamen) Co., Ltd., Xiamen (CN)

(21) Appl. No.: 19/223,553

(22) Filed: May 30, 2025

(30) Foreign Application Priority Data
Dec. 30, 2024 (CN) 202411969133.X

(51) Int. Cl. G02B 5/20; G02B 7/02

(52) U.S. Cl. CPC G02B 5/208; G02B 7/021

(57) ABSTRACT

An optical lens is provided by the present invention. The optical lens comprises a barrel and a plurality of lens elements. Each of the lens elements comprises an object-side surface facing an object side and an image-side surface facing an image side. The lens elements comprise at least one visible-light absorbable lens element. The optical lens may satisfy at least two inequalities to save cost, reduce sizes and provide good optical quality as well.

### TECHNICAL FIELD

The present disclosure relates to an optical lens, and particularly, to an optical lens which is able to absorb visible light.

### BACKGROUND

As portable electronic devices are getting more and more miniaturized, demand for miniaturized optical lenses is getting more and more increased. Cost of processing is high because processing difficulty is high for such optical lenses with small sizes. Cost of filter is over a half of the total cost of the whole optical lens. Further, when an optical lens is used for infrared light (IR), as shown in FIG. 1 which shows transmittance data of a conventional lens, a certain portion of visible light may pass through the conventional lens. As such, to improve quality of the optical lens, increasing the transmittance of IR to filter noises, caused by the light of other waveband, is necessary. Besides, if the center waveband of an optical lens is shifted from 850 nm, which covers most traditional IR optical lenses, to 940 nm, such optical lens would provide a better adaptation of night vision and safety and privacy requirements on some occasions due to its low illuminance, thereby better user experience on these special occasions.

Therefore, how to save the cost of manufacturing an optical lens, shrink its volume and meet every requirement of optical quality at the same time is a problem to be saved in the industry.

### SUMMARY

The present invention provides an optical lens used in a portable electronic device or a miniaturized product for sensing, identifying or taking a photo and/or shooting a video, etc. The portable electronic device or miniaturized product may be, for example, cell phone, digital camera, tablet computer, in-vehicle camera, personal digital assistant (PDA), and augmented reality (AR) or virtual reality (VR) wearable device. The optical lens may absorb at least one waveband of visible light through at least one visible-light absorbable lens element which is positioned in a barrel. Preferably, an optical lens of the present invention may satisfy at least two inequalities to provide good optical quality, and saving cost and shrinking volume, as a premise.

An aspect of the present invention is to provide an optical lens, comprising a barrel and a plurality of lens elements. The lens elements are positioned in the barrel from an object side to an image side along an optical axis. Each of the lens elements comprises an object-side surface facing an object side and allowing light passing through and an image-side surface facing an image side and allowing light passing through. The lens elements may comprise at least one visible-light absorbable lens element.

In the present disclosure, parameters used herein may be chosen from but not limited to the parameters listed below:

| Parameter | Definition |
|---|---|
| LW50 | A wavelength at which a transmittance in an optical lens reaches |
| | 50% in a long waveband, in which the long waveband is |
| | 700 nm~1100 nm. |
| LWmax | A wavelength at which a transmittance in an optical lens reaches |
| | a maximum value in a long waveband, in which the long waveband |
| | is 700 nm~1100 nm. |
| ODLmax | A maximum outer diameter of a lens element in the optical lens. |
| THKBmin | A minimum thickness of a barrel perpendicular to the optical axis. |
| BFL | A distance between the image-side surface of one of the lens |
| | elements, which is the closest one among the lens elements to |
| | the image side, and an image plane on the optical axis. |
| ODIBmax | A maximum inner diameter of the barrel perpendicular to the |
| | optical axis. |
| ODOBmax | A maximum outer diameter of the barrel perpendicular to the |
| | optical axis. |
| THKRHmax | A maximum thickness of a retainer parallel to the optical axis. |
| WRVmax | A maximum width of the retainer perpendicular to the optical axis. |
| Tavg | An average thickness of the lens elements on the optical axis. |
| ALT | A sum of thickness of all of the lens elements in the optical lens |
| | on the optical axis. |
| LBAVmax | A maximum length of the barrel mirrored around the optical axis. |
| T3878 | An maximum transmittance for light, a waveband of which is between |
| | 380 nm~780 nm. |
| T9296 | An maximum transmittance for light, a waveband of which is between |
| | 920 nm~960 nm. |

An embodiment of the present invention provides an optical lens, which satisfies Inequality (1): 1.20≤(LW50-700)/(LWmax−LW50)≤4.50 and Inequality (2): 1.00≤ODLmax/THKBmin≤16.67.

Another embodiment of the present invention provides an optical lens, which satisfies Inequality (1) and Inequality (3): 0.53≤ODLmax/BFL≤35.71.

One embodiment of the optical lens may further satisfy any one of inequalities as follows:
Inequality (4): 0.80≤ODIBmax/BFL≤81.43;
Inequality (5): 0.53≤ODLmax/THKRHmax≤16.67;
Inequality (6): 1.60≤ODLmax/WRVmax≤16.67;
Inequality (7): 0.10≤THKBmin/Tavg≤8.00;
Inequality (8): 0.25≤ALT/THKBmin≤8.00;
Inequality (9): 1.00≤LBAVmax/THKBmin≤23.33;
Inequality (10): 1.88≤ODOBmax/THKBmin≤40.00; and/or
Inequality (11): 6.30≤(T9296/10)/T3878≤40.20.

Optionally, according to the optical lens of the present invention, the visible-light absorbable lens element may be placed within the lens elements, as the one which is closest to the object side.

Optionally, according to the optical lens of the present invention, a retainer, which is positioned against an image-side surface of one of the lens element which is closest to the image side, may be comprised.

Optionally, according to the optical lens of the present invention, the visible-light absorbable lens element may comprise a first coating layer which may comprise titanium oxide (Ti₃O₅) and silicon dioxide (SiO₂).

Optionally, according to the optical lens of the present invention, the optical lens may omit an optical element, which is capable to filter rays and positioned between one of the lens element which is closest to the image side and a sensing element among the lens elements.

Optionally, according to the optical lens of the present invention, the visible-light absorbable lens element may be made by a resin material, and a maximum transmittance of light, a waveband of which is between 380 nm˜780 nm, in the visible-light absorbable lens element for light, may be less than or equal to 5%.

Optionally, according to the optical lens of the present invention, a visible-light absorbable lens element, which may be placed within the lens elements, as the second one which is counted from the object side, may be comprised.

Optionally, according to the optical lens of the present invention, another visible-light absorbable lens element, which may be placed within the lens elements, as the third one which is counted from the object side, may be comprised.

### BRIEF DESCRIPTION OF THE DRAWINGS

Exemplary embodiments will be more readily understood from the following detailed description when read in conjunction with the appended drawing, in which:

FIG. 1 shows a chart of transmittance data of a traditional lens element;

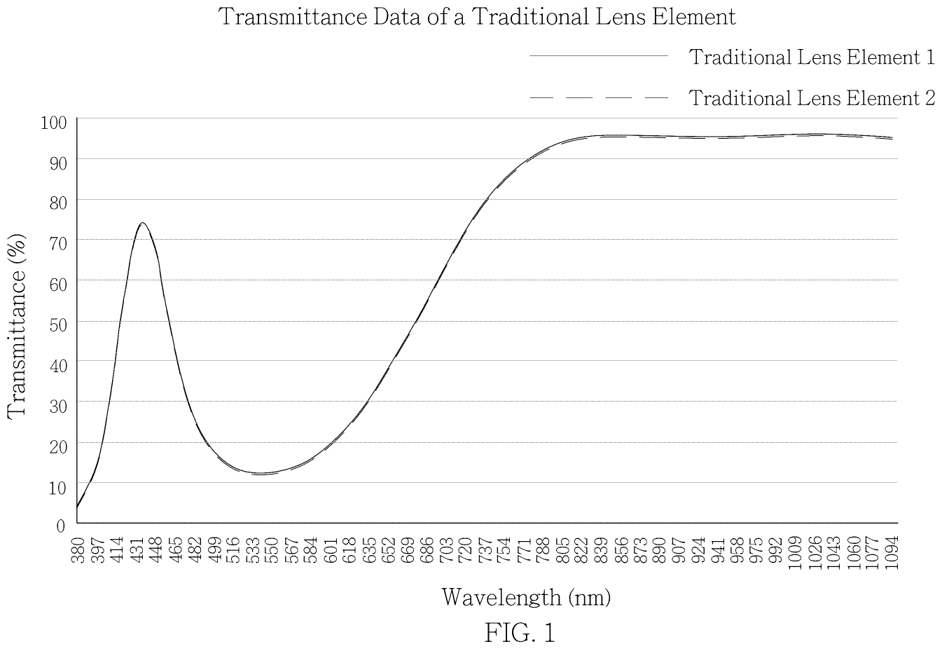

FIG. 2 depicts a perspective view of a visible-light absorbable lens element of an optical lens according to a first embodiment of the present disclosure;

FIG. 3 depicts a chart of transmittance data of four exemplary visible-light absorbable lens elements which are made in the form of the visible-light absorbable lens elements of FIG. 2;

FIG. 4 depicts a cross-sectional view of an optical lens according to the first embodiment of the present disclosure;

FIG. 5 depicts a chart of transmittance data of five exemplary optical lenses which are made in the form of the optical lens of FIG. 4;

FIG. 6 depicts a chart of transmittance data of six exemplary optical lenses comprising/not comprising a filter;

FIG. 7 depicts a table listing value of parameters of the optical lenses of the first, second and third embodiments.

### DETAILED DESCRIPTION

For a more complete understanding of the present disclosure and its advantages, reference is now made to the following description taken in conjunction with the accompanying drawings, in which like reference numbers indicate like features. Persons of ordinary skill in the art having the benefit of the present disclosure will understand other variations for implementing embodiments within the scope of the present disclosure, including those specific examples described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

In the present disclosure, an optical lens may comprise a plurality of lens elements, from an object side to an image side along an optical axis, in a barrel to receive rays that are incident on the optical lens over a set of angles ranging from parallel to the optical axis to a half field of view (HFOV) angle with respect to the optical axis. After at least one waveband of the rays is absorbed by at least one visible-light absorbable lens element contained in the lens elements, the other wavebands passing through the optical lens can be sensed by a sensing element such as a light sensor. Preferably, the optical lenses in the present disclosure may absorb at least one waveband of visible light and facilitate for passing of infrared light, so as to be adapted to infrared light application. More preferably, the optical lenses in the present disclosure may satisfy at least two inequalities to save cost and shrink volume, as well as providing a good optical quality. The lens elements is not limited to a certain quantity and shape. A number of embodiments are provided below to illustrate the implementation of the present invention.

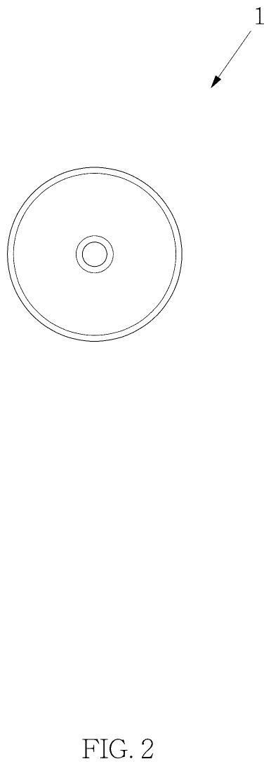

At first, FIG. 2, which depicts a perspective view of a visible-light absorbable lens element of an optical lens according to a first embodiment of the present disclosure, is referred. Please note that a lens element 1 shown in FIG. 2 is merely an example; however, the structure and shape of a visible-light absorbable lens element are not limited to this. The detailed characteristics of lens 1 are described herein. The lens element 1 may comprise two surfaces, which are configured as predetermined object-side or image-side surfaces facing an object side A1/image side A2. The lens element 1 may be formed with an optical portion and an optional mounting portion radially from inside out. When the lens element 1 is configured in an optical lens, a central point of a surface of the lens element 1 is preferably a point of intersection of that surface and the optical axis. For example, the central point is the intersection point of the object-side or image-side surface and the optical axis. The so-called “optical portion of a lens element” is defined as a portion corresponding to specific range within which the rays passing through a surface of the lens element. The so-called “rays” include at least two types of rays: a chief ray and a marginal ray. The so-called “optional mounting portion” is defined as a portion of the lens element extending radially outward from an optical boundary of a surface of the lens element, and is about the portion of the lens element excluding the optical portion. Therefore, the rays do not reach the mounting portion. The mounting portion is typically used to physically secure the lens element to a corresponding element of the optical system. The structure and shape of the mounting portion are only examples to explain the technologies, and should not be taken as limiting the scope of the present disclosure. The so-called “optical boundary of a surface of a lens element” is defined as a point at which the radially outermost marginal ray passing through the surface of the lens element intersects the surface of the lens element. The structure and shape of the optical portion is not intended to limit the scope of the invention.

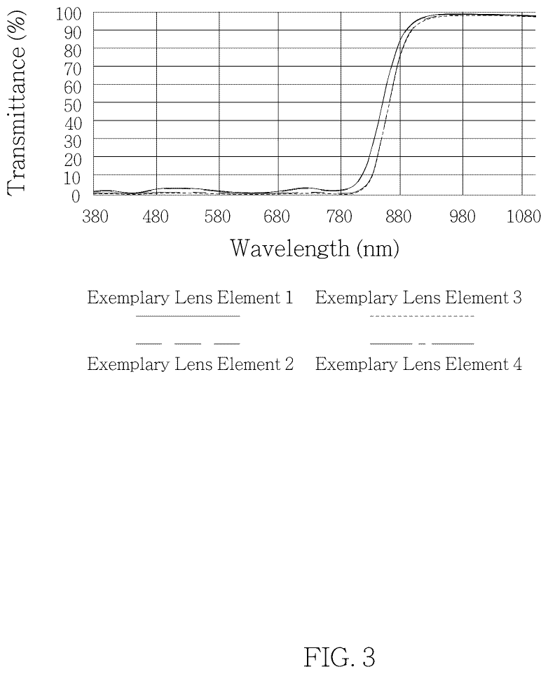

Here, a special material the nature of which is to absorb a visible-light waveband is utilized for example to make a lens element 1, as the visible-light absorbable lens element. Then, when rays are incident into the lens element 1, the visible-light waveband is absorbed. Such special material may be resin or the like, and the color of the special material may be black. As shown in FIG. 3, from transmittance data of four exemplary visible-light absorbable lens elements measured by TMS-ADV, it is understood that when rays are incident into the exemplary visible-light absorbable lens elements, within 380 nm˜780 nm among them, the preferable transmittance is less than or equal to 5%, the more preferable transmittance is less than 3.5%, and the best transmittance falls within the waveband of 940+/−20 nm. As such, it is beneficial to filter noises in the visible-light waveband, so as to promote optical quality.

In the present embodiment, on any surface of the visible-light absorbable lens element, an additional first coating layer may be formed optionally. The first coating layer may comprise, for example, titanium oxide (Ti₃O₅) and silicon dioxide (SiO₂) to reduce reflectivity of IR on the visible-light absorbable lens element. Preferably, after coating the first coating layer on the visible-light absorbable lens element, the reflectivity of IR may be decreased from 4˜5% to less than 1%.

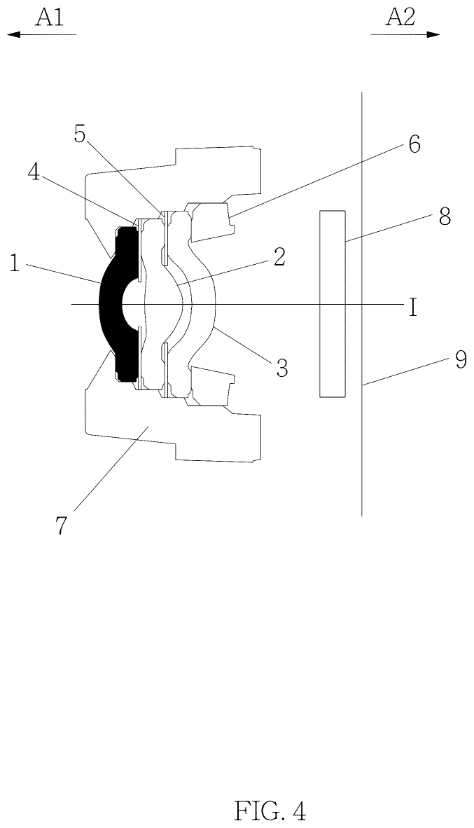

The visible-light absorbable lens element of the present embodiment may be assembled in an optical lens, a cross-sectional view of an example of which was shown in FIG. 4. The optical lens may comprise, for example, three lens elements 1, 2, 3, the quantity and shape of which are exemplary, two light-shielding plates 4, 5, a retainer 6, a barrel 7, a cover lens 8 and a sensor 9. The lens elements 1, 2, 3 is positioned from an object side A1 to an image side A2 along an optical axis I in the barrel 7 with the light-shielding plates 4, 5 positioned between two adjacent lenses 1, 2 or 2, 3 of the lens elements 1, 2, 3 blocking stray lights. Then, the retainer 6 is positioned against the image side A2 of the last lens element 3 of the lens elements 1, 2, 3 so as to fix the lens elements 1, 2, 3 inside the barrel 7 and avoid from moving of the lens elements 1, 2, 3. At least one of the lens elements 1, 2, 3, such as the first lens element counted from the object side A1, i.e. the lens element 1, may be the visible-light absorbable lens element. As such, it is beneficial to filter visible-light noises to promote optical quality. From the transmittance data of the four exemplary visible-light absorbable lens elements, as shown in FIG. 3, major of rays passing through the visible-light absorbable lens element are IR a center waveband of which is 940 nm. Finally, rays passing through the cover lens 8 are sensed by the sensor 9 protected by the cover lens 8. The sensor 9 may be a IR sensor.

Please note that in the optical lens of the present embodiment, no filtering unit, such as a filter, is used. Because filtering unit with small sizes is usually expensive, such configuration is beneficial to decrease the quantity of optical elements, so as to shrink volume of the optical lens and save cost on the filtering unit. However, in some other embodiments, a filtering unit, such as a filter, may be optionally positioned between an image side of a lens element which is the closest one to the image side and a sensor. On at least one surface of the filtering unit, at least one film, such as a visible-light filtering film, a film reducing reflectivity, and/or other films, may be formed optionally, depending on requirements. The film reducing reflectivity may be, but not limited to, Ti₃O₅ and SiO₂ for example.

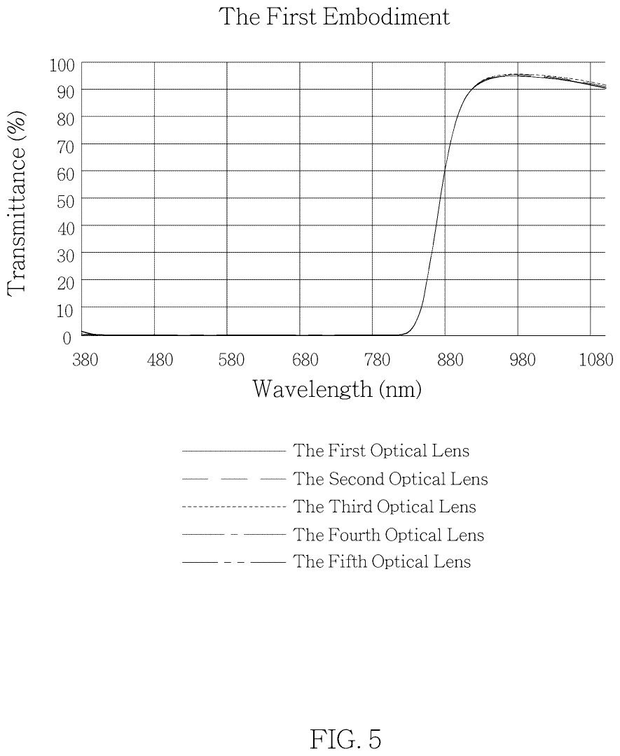

From FIG. 5, which shows a chart of transmittance data of five exemplary optical lenses which are made in the form of the optical lens of FIG. 4, measured with a TMS-ADV transmittance measuring apparatus, it is known that when rays are incident into the exemplary optical lenses, a maximum transmittance within 380 nm˜780 nm is preferably less than or equal to 5%, and more preferably, less than 1.5%.

In another embodiment, the visible-light absorbable lens element may be a lens element which is the closest one to the object side among the lens elements, and such configuration is beneficial to provide a fully blackened appearance (i.e. fully blackened lens). Then, the appearance of the whole optical lens is in a relatively consistency, and such optical lens may filter more noises of other wavebands. Because most visible light is absorbed by the visible-light absorbable lens element at first, surfaces of lens elements may be blackened in a deeper black, so as to reduce the reflectivity of visible light in the whole system to decrease stray light.

In other embodiments, a plurality of visible-light absorbable lens elements may be comprised in the lens elements to promote absorption of visible light. The visible-light absorbable lens element may be a second lens element and a third lens element, counted from the object side A1 among the lens elements. Such configuration is beneficial to absorb visible light and filter noises, so as to, but not limited to, provide a better optical quality.

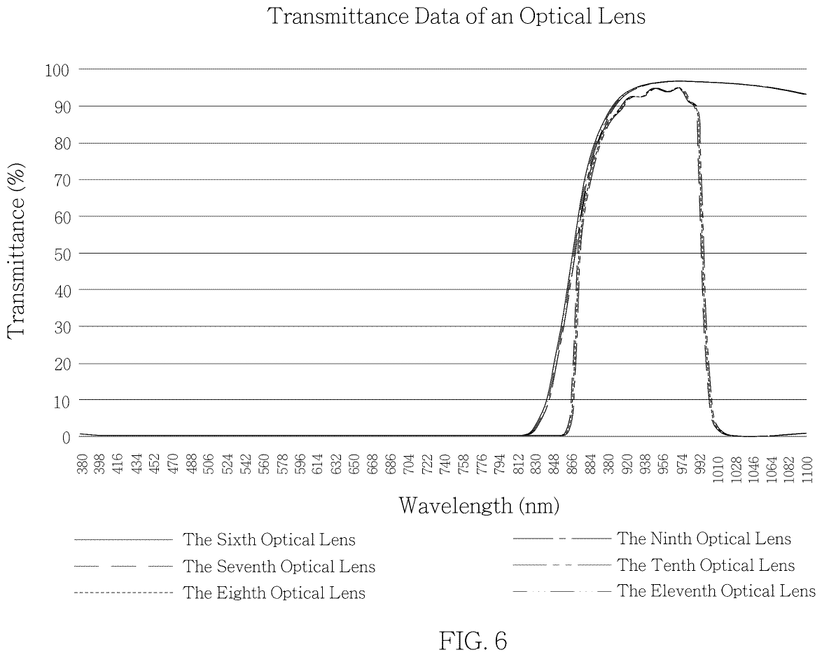

Referring to FIG. 6, a chart of transmittance data of six exemplary optical lenses comprising/not comprising a filter, which are made in the form of the optical lens of FIG. 4, is shown. In FIG. 6, first three optical lenses do not comprise a filter and last three optical lenses do comprise a filter. As shown in FIG. 6, with respect to IR, a center waveband of which is 940 nm, existence of a filter does not affect the transmittance in a great deal, and this may prove that the visible-light absorbable lens element may be used to replace a filter in terms of absorbance of visible light.

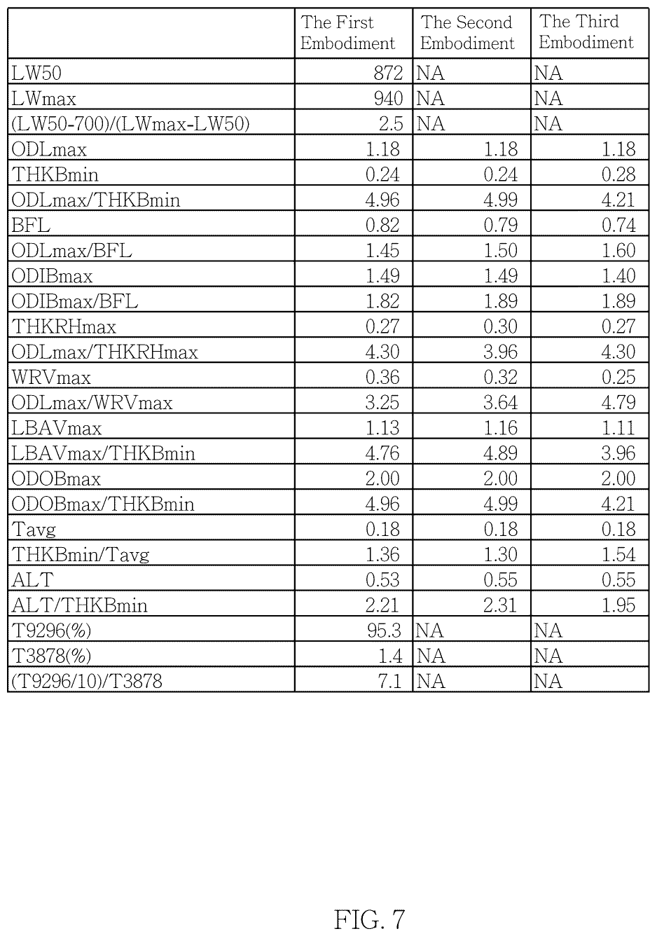

Here, a table listing value of parameters of the optical lenses of the first, second and third embodiments is shown in FIG. 7. Definition of each parameter is as mentioned above. Preferably, LW50 is within 850 nm˜880 nm, LWmax is within 920 nm˜980 nm, ODLmax is within 0.80 mm˜2.50 mm, THKBmin is within 0.15 mm˜0.80 mm, BFL is within 0.07 mm˜1.50 mm, ODIBmax is within 1.20 mm˜5.70 mm, THKRHmax is within 0.15 mm˜1.50 mm, WRVmax is within 0.15 mm˜0.50 mm, LBAVmax is within 0.80 mm˜3.50 mm, ODOBmax is within 1.50 mm˜6.00 mm, Tavg is within 0.10 mm˜1.50 mm, ALT is within 0.20 mm˜1.20 mm, T9296(%) is within 94.9%˜99.0%, and T3878(%) is within 0.2%˜1.5%. From FIG. 7, it is known that the optical lens of the first embodiment satisfies Inequality (1): 1.20≤(LW50-700)/(LWmax-LW50)≤4.50, the optical lenses of the first, second and third embodiments satisfy Inequality (2): 1.00≤ODLmax/THKBmin≤16.67 or Inequality (3): 0.53≤ODLmax/BFL≤35.71.

In an embodiment, preferably, the optical lens may additionally satisfy at least one inequalities, listed below:
Inequality (4): 0.80≤ODIBmax/BFL≤81.43;
Inequality (5): 0.53≤ODLmax/THKRHmax≤16.67;
Inequality (6): 1.60≤ODLmax/WRVmax≤16.67;
Inequality (7): 0.10≤THKBmin/Tavg≤8.00;
Inequality (8): 0.25≤ALT/THKBmin≤8.00;
Inequality (9): 1.00≤LBAVmax/THKBmin≤23.33;
Inequality (10): 1.88≤ODOBmax/THKBmin≤40.00; and/or
Inequality (11): 6.30≤(T9296/10)/T3878≤40.20.

When the optical lens satisfies Inequality (1), it may have a better concealment to promote comfortability and be better adapted to night vision and requirements of safety and privacy under some scenarios. Furthermore, when the optical lens satisfies Inequalities (1) and (2) at the same time by matching the maximum outer diameter of the lens element and thickness of the barrel, a volume of the optical lens in a radial direction may be decreased, and a quantity of filter may be reduced, so as to reduce the quantity of optical elements and save cost of production. Preferably, the optical lens may satisfy 1.50≤(LW50-700)/(LWmax-LW50)≤3.50 and 4.00≤ODLmax/THKBmin≤10.00.

By matching the maximum outer diameter of the lens element and thickness of the barrel, when the optical lens satisfies Inequalities (1) and (3) at the same time, a filter can be omitted, so as to reduce a systematic length of the optical lens and a back focal distance, and shrink the volume of the optical lens in both radial direction and optical axis direction. Preferably, the optical lens may satisfy 1.50≤(LW50-700)/(LWmax-LW50)≤3.50 and 1.30≤ODLmax/BFL≤2.00.

If the optical lens satisfies Inequality (4), it is beneficial to save cost of manufacturing the optical lens and shrink the volume of the optical lens. Preferably, the optical lens may satisfy 1.50≤ODIBmax/BFL≤2.00.

If the optical lens satisfies Inequality (5), it is beneficial to save cost of manufacturing the optical lens, and preferably, the optical lens may satisfy 3.50≤ODLmax/THKRHmax≤4.50.

If the optical lens satisfies Inequality (6), it is beneficial to save cost of manufacturing the optical lens, and preferably, the optical lens may satisfy 3.00≤ODLmax/WRVmax≤5.00.

If the optical lens satisfies Inequality (7), it is beneficial to save cost of manufacturing the optical lens, and preferably, the optical lens may satisfy 1.00≤THKBmin/Tavg≤2.00.

If the optical lens satisfies Inequality (8), it is beneficial to save cost of manufacturing the optical lens, and preferably, the optical lens may satisfy 1.50≤ALT/THKBmin≤2.50.

If the optical lens satisfies Inequality (9), it is beneficial to save cost of manufacturing the optical lens, and preferably, the optical lens may satisfy 3.50≤LBAVmax/THKBmin≤5.00.

If the optical lens satisfies Inequality (10), it is beneficial to save cost of manufacturing the optical lens, and preferably, the optical lens may satisfy 4.00≤ODOBmax/THKBmin≤5.00.

If the optical lens satisfies Inequality (11), it is beneficial to absorb visible light, filter noises and provide a better optical quality.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

In view of unpredictable nature of an optical lens, based on the present invention, when an optical lens meets at least one aforesaid inequality, its the lens elements may save the cost of manufacturing an optical lens, shrink its volume and meet every requirement of optical quality at the same time to solve the problem of conventional systems.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical lens, comprising:
a barrel;
a plurality of lens elements, positioned in the barrel from an object side to an image side along an optical axis, each of the lens elements having an object-side facing the object side and allowing light passing through and an image-side facing the image side and allowing light passing through, the lens elements comprising at least one visible-light absorbable lens element; and
wherein the optical lens satisfies inequalities: 1.20≤(LW50-700)/(LWmax-LW50)≤4.50 and 1.00≤ODLmax/THKBmin≤16.67, LW50 is a wavelength at which a transmittance in an optical lens reaches 50% in a long waveband, in which the long waveband is 700 nm˜1100 nm, LWmax is a wavelength at which a transmittance in an optical lens reaches a maximum value in a long waveband, in which the long waveband is 700 nm˜1100 nm, ODLmax is a maximum outer diameter of a lens element in the optical lens, and THKBmin is a minimum thickness of a barrel perpendicular to the optical axis.

2. The optical lens according to claim 1, wherein the at least one visible-light absorbable lens element is the one which is closest to the object side among the lens elements.

3. The optical lens according to claim 1, further comprising a retainer positioned against an image-side surface of one of the lens element which is closest to the image side, and further satisfying an inequality: 0.53≤ODLmax/THKRHmax≤16.67, and THKRHmax being a maximum thickness of a retainer parallel to the optical axis.

4. The optical lens according to claim 1, further comprising a retainer positioned against an image-side surface of one of the lens element which is closest to the image side, and further satisfying an inequality: 1.60≤ODLmax/WRVmax≤16.67, and WRVmax being a maximum width of the retainer perpendicular to the optical axis.

5. The optical lens according to claim 1, wherein the at least one visible-light absorbable lens element further comprises a first coating layer comprising titanium oxide (Ti₃O₅) and silicon dioxide (SiO₂).

6. The optical lens according to claim 1, further satisfying an inequality: 6.30≤(T9296/10)/T3878≤40.20, T3878 being an maximum transmittance for light, a waveband of which is between 380 nm˜780 nm, and T9296 being a maximum transmittance for light, a waveband of which is between 920 nm˜960 nm.

7. The optical lens according to claim 1, further comprising another visible-light absorbable lens element, which may be placed within the lens elements, as the second one which is counted from the object side.

8. An optical lens, comprising:
a barrel;
a plurality of lens elements, positioned in the barrel from an object side to an image side along an optical axis, each of the lens elements having an object-side facing the object side and allowing light passing through and an image-side facing the image side and allowing light passing through, the lens elements comprising at least one visible-light absorbable lens element; and
wherein the optical lens satisfies inequalities: 1.20≤(LW50-700)/(LWmax-LW50)≤4.50 and 0.53≤ODLmax/BFL≤35.71, LW50 is a wavelength at which a transmittance in an optical lens reaches 50% in a long waveband, in which the long waveband is 700 nm˜1100 nm, LWmax is a wavelength at which a transmittance in an optical lens reaches a maximum value in a long waveband, in which the long waveband is 700 nm˜1100 nm, ODLmax is a maximum outer diameter of a lens element in the optical lens, and BFL is a distance between the image-side surface of one of the lens elements, which is the closest one among the lens elements to the image side, and an image plane on the optical axis.

9. The optical lens according to claim 8, wherein the optical lens further satisfies an inequality: 0.80≤ODIBmax/BFL≤81.43, ODIBmax is a maximum inner diameter of the barrel perpendicular to the optical axis.

10. The optical lens according to claim 8, further satisfying an inequality: 0.10≤THKBmin/Tavg≤8.00, Tavg being an average thickness of the lens elements on the optical axis, and THKBmin being a minimum thickness of a barrel perpendicular to the optical axis.

11. The optical lens according to claim 8, further satisfying an inequality: 0.25≤ALT/THKBmin≤8.00, ALT being a sum of thickness of all of the lens elements in the optical lens on the optical axis, and THKBmin being a minimum thickness of a barrel perpendicular to the optical axis.

12. The optical lens according to claim 8, further satisfying an inequality: 1.00≤LBAVmax/THKBmin≤23.33, LBAVmax being a maximum length of the barrel mirrored around the optical axis, and THKBmin being a minimum thickness of a barrel perpendicular to the optical axis.

13. The optical lens according to claim 8, further satisfying an inequality: 1.88≤ODOBmax/THKBmin≤40.00, ODOBmax being a maximum outer diameter of the barrel perpendicular to the optical axis, and THKBmin being a minimum thickness of a barrel perpendicular to the optical axis.

14. The optical lens according to claim 8, wherein no filtering unit is positioned between one of the lens elements which is closest to the image side and a sensor.

15. The optical lens according to claim 8, wherein the at least one visible-light absorbable lens element is constructed by resin, and a maximum transmittance of light, a waveband of which is 380 nm˜780 nm, in the at least one visible-light absorbable lens element is less than or equal to 5%.

16. The optical lens according to claim 8, further comprising another visible-light absorbable lens element, which may be placed within the lens elements, as the third one which is counted from the object side.
